(19) United States
(12) Patent Application Publication
(10) Pub. No.: US 2013/0133420 A1
(43) Pub. Date: May 30, 2013

(54) HUMIDITY SENSOR AND METHOD OF SENSING HUMIDITY

(71) Applicants: CHUNG-CHIN HUANG, Taichung (TW); Chin-Ying Huang, Taichung (TW); Hsin-Ming Huang, Taichung (TW); Hsing-Hsiung Huang, Taichung (TW)

(72) Inventors: CHUNG-CHIN HUANG, Taichung (TW); Chin-Ying Huang, Taichung (TW); Hsin-Ming Huang, Taichung (TW); Hsing-Hsiung Huang, Taichung (TW)

(73) Assignee: GRAND MATE CO., LTD., TAICHUNG (TW)

(21) Appl. No.: 13/308,005

(22) Filed: Nov. 30, 2011

(51) Int. Cl. G01N 27/12

(52) U.S. Cl. 73/335.05

(57) ABSTRACT

The present invention provides a humidity sensor including a first conductor, a second conductor, a power supply unit, and a current sensing unit. The first and the second conductors are separated from each other for a predetermined distance and are placed at a predetermined place. The power supply unit supplies high voltage to the first conductor, and the current sensing unit senses a change of current in the conductor and generate a signal in association with the change of the current. Therefore, the humidity sensor may operate in any environment, such as high temperature and high pressure.

### BACKGROUND OF THE INVENTION

1. Field of the Invention

The present invention relates generally to a measurement of humidity, and more particularly to a humidity sensor and a method of sensing humidity.

2. Description of the Related Art

With advancement in technology, humidity has a huge affect on manufacture, maintain, and operation of electronic devices. Typically, there are two types of humidity sensors, including mechanic humidity sensor and electronic humidity sensor. The mechanic humidity sensor usually is operated as a switch. The mechanic humidity sensor is provided with a film therein, which is deformed because of humidity. The deformation of the film is proportional to the humidity that the sensor may be turned on or off by the humidity. This kind of switch is precise, but it is huge and heavy. Besides, it only provides an ON/OFF signal.

The conventional electronic humidity sensor is provided with small chips and circuits therein, and it usually includes an infrared ray sensor to sense relative humidity and output a predetermined voltage is association with the humidity. The electronic humidity sensor may be made smaller and lighter, and may show a real-time humidity. However, it may be affected by some environment conditions, such as temperature and pressure. In conclusion, there still are some issues to be improved for a humidity sensor.

### SUMMARY OF THE INVENTION

The primary objective of the present invention is to provide a humidity sensor and a method of sensing humidity, which has a precise measurement and may be operated in a high-temperature environment.

According to the objective of the present invention, the present invention provides a humidity sensor including a first conductor, a second conductor, a power supply unit, and a current sensing unit. The first and the second conductors are separated from each other for a predetermined distance and are placed at a predetermined place. The power supply unit supplies high voltage to the first conductor, and the current sensing unit senses a change of current in the conductor and generate a signal in association with the change of the current.

In an embodiment, the humidity sensor further includes a calculating unit coupled to the current sensing unit to receive the signal from the current sensing unit and obtain a humidity value according to the signal.

In an embodiment, the humidity sensor further includes an adjusting unit between the calculating unit and the current sensing unit to adjust the signal from the current sensing unit and send the signal to the calculating unit.

In an embodiment, the humidity sensor further includes a display connected to the calculating unit to show the humidity value.

The present invention further provides a method of sensing humidity, including the following steps:

A. Locate a first conductor and a second conductor at a place, wherein the first conductor and the second conductor are separated from each other for a predetermined distance.

B. Provide one of the first conductor and the second conductor high voltage.

C. Sense a change of current in one of the first conductor and the second conductor; and

D. Obtain a signal in association with the change of the current.

In an embodiment, the method further includes the step E of receiving the signal from the current sensing unit and obtain a humidity value according to the signal.

In an embodiment, the method further includes the step f adjusting the signal from the current sensing unit prior to obtaining the humidity value.

In an embodiment, the method further includes the step F of displaying the humidity value.

Therefore, the present invention may sense humidity in any environment, such as high temperature and high pressure.

### BRIEF DESCRIPTION OF THE DRAWINGS

FIG. 1 is a block diagram of the humidity sensor of a preferred embodiment of the present invention;

FIG. 2 is a flow chart of the method of sensing humidity of the preferred embodiment of the present invention;

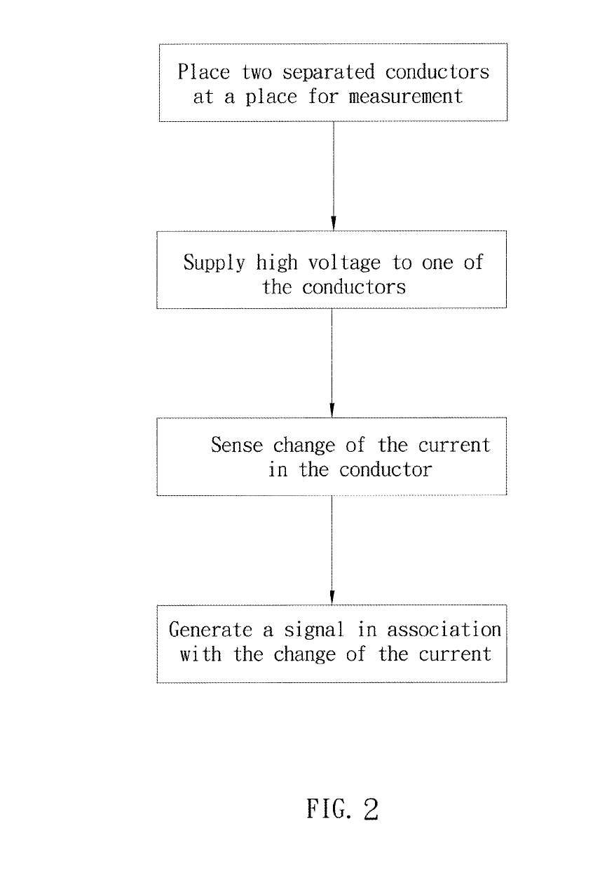

FIG. 3 is an alternative design with the adjusting unit of the humidity sensor of the preferred embodiment of the present invention;

FIG. 4 is an alternative design with the calculating unit and the display of the humidity sensor of the preferred embodiment of the present invention; and

FIG. 5 is an alternative design with the calculating unit and the display in separated design of the humidity sensor of the preferred embodiment of the present invention.

### DETAILED DESCRIPTION OF THE INVENTION

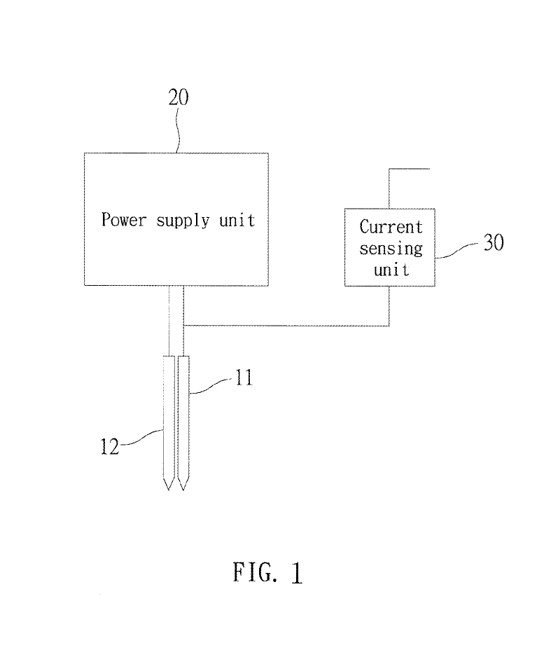

FIG. 1 shows a humidity sensor of the preferred embodiment of the present invention, including a first conductor 11, a second conductor 12, a power supply unit 20, and a current sensing unit 30.

The first and the second conductors 11, 12 are separated from each other for a predetermined distance. In the preset invention, the conductors 11 and 12 are metallic probe-like members.

The power supply unit 20 electrically connects the first and the second conductors 11 and 12 respectively to provide the first conductor 11 high voltage. In the present invention, the power supply unit 20 has an isolation transformer to transform power from an external power supply into the high voltage.

The current sensing unit 30 is connected to the first conductor 11 or the second conductor 12 to sense a change of current in the conductor 11 or 12. In the present invention, the current sensing unit 30 is connected to the first conductor 11, and, however, it may be connected to the second conductor 12 also.

A method of sensing humidity by the humidity sensor as described above includes the following steps:

A. Place the first conductor 11 and the second conductor 12 at a place where the humidity is detected. The first and the second conductors 11, 12 are separated from each other for a predetermined distance. Air between the first and the second conductors 11, 12 forms a high resistance region, and a resistance of the high resistance region is proportional to the distance between the first and the second conductors 11, 12.

B. Provide high voltage to one of the conductors 11 or 12. In the present invention, the power supply unit 20 is connected to the first conductor 11. When the voltage is higher than a value, it will discharge and pass through the high resistance region, therefore, there will be a current in the conductors 11 and 12.

C. Sense a change of the current in the conductor 11 or 12. When the humidity at the high resistance region gets higher, the resistance of the high resistance region reduces that the current in the conductor 11 or 12 raises. On the contrary, when the humidity at the high resistance region reduces, the resistance of the high resistance region raises, and the current in the conductor 11 or 12 reduces. In the present invention, the current in the first conductor 11 is detected by the current sensing unit 30.

D. Generate a signal in association with the change of the current sensed by the current sensing unit 30. It may get a change of humidity according to the signal.

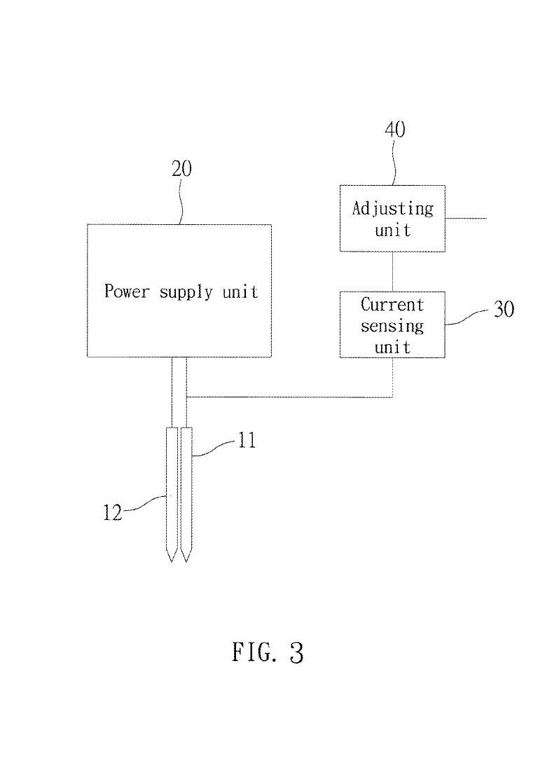

As shown in FIG. 3, to allow the humidity sensor of the present invention works in different environments, the humidity sensor may further provides an adjusting unit 40 electrically connected to the current sensing unit 30 to provide a more precise measurement. In the present invention the adjusting unit 40 includes multiplier and adder to reset, fine adjust, or multiple the signal from the current sensing unit 30. Therefore, it further includes the step E after the step D which is adjusting the signal from the current sensing unit 30 to get a precise measurement.

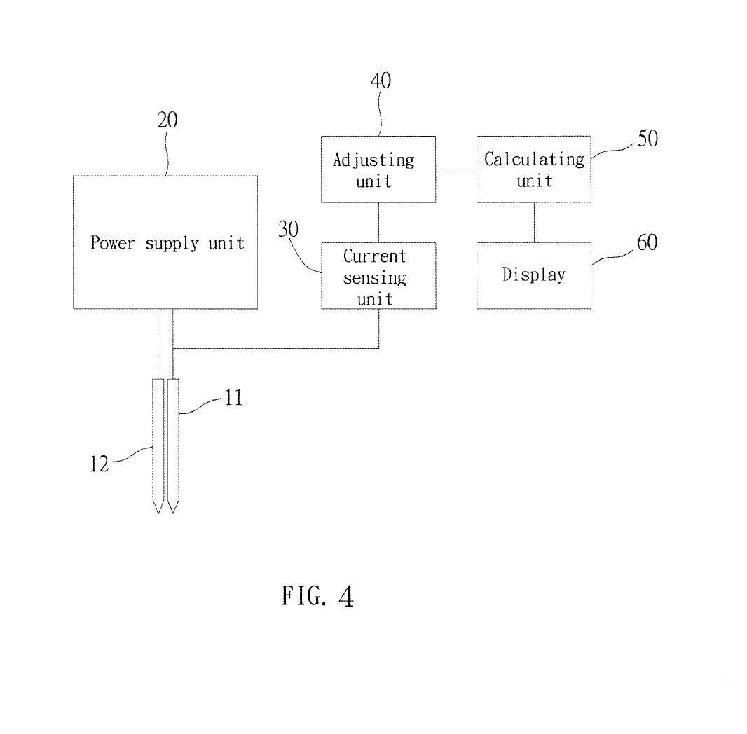

As shown in FIG. 4, the humidity sensor of the present invention further is provided with a calculating unit 50 and a display 60. The calculating unit 50 is coupled to current sensing unit 30 through the adjusting unit 40, and the display 60 is connected to the calculating unit 50. Therefore, the calculating unit 50 receives the signal from the adjusting unit 40 to obtain a humidity value according to the signal, and show the humidity value on the display 60. In other words, there is step F after step E to obtain a humidity value according to the signal from the adjusting unit 40, and show the humidity value on the display 60. As a result, user may watch the display 60 for a real-time humidity.

It is noted that the calculating unit 50 may be directly connected or coupled to the current sensing unit 30 without the adjusting unit 40 that the step E will be receiving the signal from the current sensing unit 30 to obtain a humidity value according to the signal.

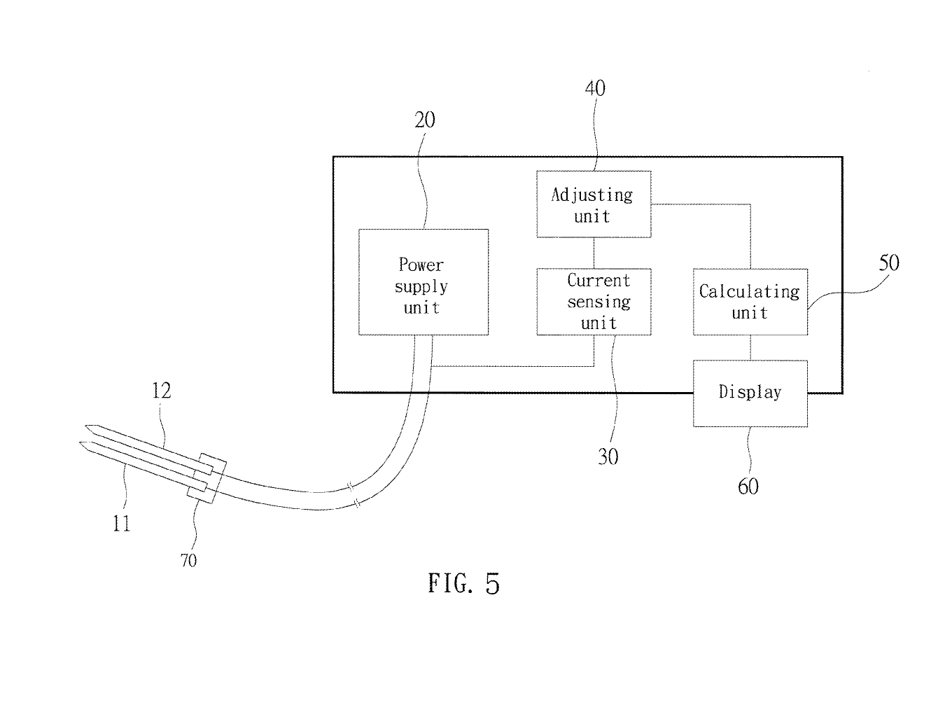

As shown in FIG. 5, the conductors 11, 12 are connected to the power supply unit 20 through two long wires that only the conductors 11, 12 are placed at the place for measurement, and the rest elements are far away from the place. Therefore, the environment conditions, such as temperature and pressure, will not affect the electronic elements of the humidity sensor of the present invention, such as the power supply unit 20, the current sensing unit 30, the adjusting unit 40, the calculating unit 50, and the display 60. It means that the humidity sensor of the present invention may operate in any environment, such as high temperature and high pressure. In addition, the present invention further provides a shield member 70 connected to ends of the conductors 11, 12. The shield member 70 exposes some parts of the conductor 11, 12 to sense humidity, and seals connections of the conductors 11, 12 and the wires. The shield member 70 secures the conductor 11, 12 to keep the distance therebetween. In conclusion, the humidity sensor of the present invention may precisely sense humidity in any environment, such as high temperature environment and high pressure environment.

The description above is a few preferred embodiments of the present invention and the equivalence of the present invention is still in the scope of claim construction of the present invention.

What is claimed is:

1. A humidity sensor, comprising:
a first conductor;
a second conductor separated from the first conductor for a predetermined distance;
a power supply unit electrically connected to the first conductor and the second conductor to supply the first conductor high voltage; and
a current sensing unit electrically connected to one of the first conductor and the second conductor to sense a change of current in the conductor and generate a signal in association with the change of the current.

2. The humidity sensor as defined in claim 1, further comprising a calculating unit coupled to the current sensing unit to receive the signal from the current sensing unit and obtain a humidity value according to the signal.

3. The humidity sensor as defined in claim 2, further comprising an adjusting unit between the calculating unit and the current sensing unit to adjust the signal from the current sensing unit, and then send the signal to the calculating unit.

4. The humidity sensor as defined in claim 2, further comprising a display connected to the calculating unit to show the humidity value.

5. The humidity sensor as defined in claim 1, further comprising an adjusting unit connected to the current sensing unit to adjust the signal from the current sensing unit.

6. The humidity sensor as defined in claim 5, further comprising a shield member covering portions of the first conductor and the second conductor and expose the rest portions of the first conductor and the second conductor.

7. A method of sensing humidity, comprising the steps of:
A. locating a first conductor and a second conductor at a place, wherein the first conductor and the second conductor are separated from each other for a predetermined distance;
B. providing one of the first conductor and the second conductor high voltage;
C. sensing a change of current in one of the first conductor and the second conductor; and
D. obtaining a signal in association with the change of the current.

8. The method as defined in claim 7, wherein further comprising the step E of receiving the signal from the current sensing unit, and obtain a humidity value according to the signal.

9. The method as defined in claim 8, further comprising the step of adjusting the signal from the current sensing unit prior to obtaining the humidity value.

10. The method as defined in claim 8, further comprising the step F of displaying the humidity value.

11. The method as defined in claim 7, further comprising the step E of adjusting the signal from the current sensing unit.
